(19) United States
(12) Patent Application Publication
(10) Pub. No.: US 2024/0099927 A1
(43) Pub. Date: Mar. 28, 2024

(54) SKIN BEAUTY SUCTION DEVICE

(71) Applicant: JianDong Huang, Shenzhen City (CN)

(72) Inventors: Jiandong Huang, Shenzhen City (CN); Jiabing Xu, Shenzhen City (CN)

(21) Appl. No.: 18/184,838

(22) Filed: Mar. 16, 2023

(30) Foreign Application Priority Data
Sep. 26, 2022 (CN) 202222548449.4

(51) Int. Cl. A61H 9/00

(52) U.S. Cl. CPC A61H 9/0057; A61H 2201/0153; A61H 2201/1238; A61H 2201/5007; A61H 2201/5025; A61H 2201/5056; A61H 2201/5064; A61H 2201/5074; A61H 2201/5097; A61H 2205/022

(57) ABSTRACT

The present disclosure provides a skin beauty suction device, including: a main control board, connected to a suction pump; wherein the suction pump is connected to a suction nozzle through a gas tube, the suction nozzle being configured to be in contact with a human skin to suck blackheads; a pressure sensor is arranged between the suction pump and the suction nozzle, and the pressure sensor is electrically connected to the main control board; the main control board is electrically connected to a display. The present disclosure solves the technical problem of redness and damage to the skin due to the inability to detect and control the amount of pressure, which causes the suction device to easily apply too much force when suctioning the skin. The present disclosure has very good practical value and is easy to manufacture and use.

### CROSS REFERENCE

The present application claims foreign priority of Chinese Patent Application No. 202222548449.4, filed on Sep. 26, 2022, in the China National Intellectual Property Administration, the entire contents of which are hereby incorporated by reference in its entirety.

### TECHNICAL FIELD

The present disclosure relates to the technical field of beauty cleaning care tools, and in particular to a skin beauty suction device.

### BACKGROUND

With the improvement of people's living standard, their requirements for own appearance are getting higher and higher while material life is satisfied. Especially for some female customers, face has become one of the most relevant parts to be maintained. Blackheads are hardened grease blockages that usually appear on the forehead, nose, and other parts of the face. When the oil glands are over-stimulated and the pores are filled with excess oil and cause blockages, there is often a greasy feeling in and around the nose or on the face, forehead, and other parts. The oil will eventually harden and turn into black dots after oxidation, and these dots are the oil blockage called blackheads.

The existing solution is to suck blackheads out of the face using a skin beauty suction device with a suction tip, for example: using a suction tube with suction function to suck blackheads, but some existing products for sucking blackheads are not flexible enough and many of them are prone to the problem of facial redness and skin injury. The present disclosure will solve the technical problem of redness and skin damage due to the inability to detect and control the amount of pressure, which causes the suction device to suction the skin with too much force. For the above problem, no effective solution has been proposed.

### SUMMARY OF THE DISCLOSURE

The main purpose of the present disclosure is to provide a skin beauty suction device to solve the technical problem of redness and damage to the skin due to the inability to detect and control the amount of pressure, which causes the suction device to easily apply too much force when suctioning the skin. No effective solution has been proposed for the above problem.

In an aspect, the present disclosure provides a skin beauty suction device, including: a main control board, connected to a suction pump; wherein the suction pump is connected to a suction nozzle through a gas tube, the suction nozzle being configured to be in contact with a human skin to suck blackheads; a pressure sensor is arranged between the suction pump and the suction nozzle, and the pressure sensor is electrically connected to the main control board; the main control board is electrically connected to a display.

In some embodiments, the skin beauty suction device further includes: a handheld part and a base; wherein the handheld part and the base are connected, and the handheld part has a hollow cavity; the main control board and suction pump are fixed in the handheld part, and the suction nozzle is arranged at an end of the handheld part.

In some embodiments, the skin beauty suction device further includes a vacuum chamber; wherein the suction pump is in communication with the vacuum chamber through a gas tube, the vacuum chamber is in communication with the suction nozzle and a deflation device through a gas tube, the pressure sensor is arranged on the vacuum chamber, and the pressure sensor is electrically connected to the main control board.

In some embodiments, the pressure sensor is a piezoresistive pressure sensor, and the pressure sensor is arranged on the vacuum chamber.

In some embodiments, a wireless transmission module is further arranged in the handheld part, and the wireless transmission module is connected to the main control board and configured to transmit data from the pressure sensor to a mobile terminal.

In some embodiments, a displacement sensor is further arranged on the suction nozzle, which is connected to the main control board.

In some embodiments, the main control board is connected to a battery and is electrically connected to a power switch through a wire.

In some embodiments, the main control board is connected to a suction adjustment device, and the suction adjustment device is configured to adjust a pressure in the vacuum chamber.

In some embodiments, the skin beauty suction device further includes a pressure relief valve; wherein the main control board is connected to the pressure relief valve, and the pressure relief valve is configured to release a pressure in the vacuum chamber.

In some embodiments, the power switch, the suction adjustment device, and pressure relief valve are arranged on a sidewall of the handheld part, and the vacuum chamber is arranged in the handheld part.

The vacuum chamber is to increase the pumping volume, to facilitate accurate vacuum adjustment, and to get a stable vacuum and suction power during the use of the suction nozzle. The vacuum chamber is connected to the suction nozzle through the gas tube, the suction nozzle is in contact with the human skin, and the blackheads in the human skin are sucked out through the negative pressure; after the skin beauty suction device is turned on, the vacuum degree of the vacuum chamber gradually increases and is connected to the pressure sensor through the air tube, and the sensor detects the negative pressure value of the vacuum chamber and displays it on the display; when the negative pressure value reaches the set value, the pump automatically stops pumping; when the vacuum degree of the vacuum chamber decreases to a predetermined value, the main control board will control the suction pump to operate and issue a signal to the suction pump, which will automatically turn on the pump, and so on. In this way, the pressure can be well ensured and the damage to human skin may be reduced through the main control board for timely control. The main control board is a main board with control circuit. The suction nozzle is configured to suck blackheads on a to-be-treated part of the human body.

The pressure sensor transmits the pressure signal in the vacuum chamber to the main control board, and the main control board performs controlling.

In the present disclosure, the pressure sensor is arranged in such a way that the pressure data can be displayed when operating on the patient's to-be-treated area, thereby enabling better regulation of the suction force and reducing skin damage and redness, which solves the technical problem that the suction device tends to use too much force when sucking the skin due to the inability to detect and control the size of the pressure, which is very convenient and easy to use, and easy to manufacture and use.

### BRIEF DESCRIPTION OF THE DRAWINGS

The accompanying drawings which form part of the present disclosure are intended to provide a further understanding thereof, making other features, purposes, and advantages of the present disclosure more apparent. The illustrative embodiments of the present disclosure and the description thereof are intended to explain the present disclosure and do not constitute an undue limitation of the present disclosure.

FIG. 1 is a schematic view of circuit wiring of a skin beauty suction device according to an embodiment of the present disclosure.

FIG. 2 is a schematic view of a shape overall structure of a skin beauty suction device according to an embodiment of the present disclosure.

Reference numerals: 1, main control board; 2, suction pump; 3, vacuum chamber; 4, suction nozzle; 5, deflation device; 6, pressure sensor; 7, display; 8, power switch; 9, suction adjustment device; 10, pressure relief valve; 11, handheld part; 12, base.

### DETAILED DESCRIPTION

In order to enable those in the art to better understand the present disclosure, the following will be a clear and complete description of the technical solutions in the embodiments of the present disclosure in conjunction with the accompanying drawings in the embodiments of the present disclosure. Obviously, the embodiments described are only a part of the embodiments of the present disclosure, and not all of them. Based on the embodiments in the present disclosure, all other embodiments obtained by those skilled in the art without making creative labor shall fall within the scope of the present disclosure.

It should be noted that the term “include” in the specification, claims, and the accompanying drawings above of the present disclosure is intended to cover non-exclusive inclusion. For those skilled in the art, the specific meaning of these terms in the present disclosure can be understood on a case-by-case basis.

In addition, the term “connection” is to be understood in a broad sense. For example, it may be a fixed connection, a removable connection, or an integral construction; it may be a mechanical connection, or an electrical connection; it may be a direct connection, or an indirect connection through an intermediate medium, or an internal connection between two devices, components, or parts. To those skilled in the art, the specific meaning of the above terms in the present disclosure can be understood on a case-by-case basis.

It is to be noted that the embodiments and the features in the embodiments in the present disclosure can be combined with each other without conflict. The present disclosure will be described in detail below with reference to the accompanying drawings and in conjunction with the embodiments.

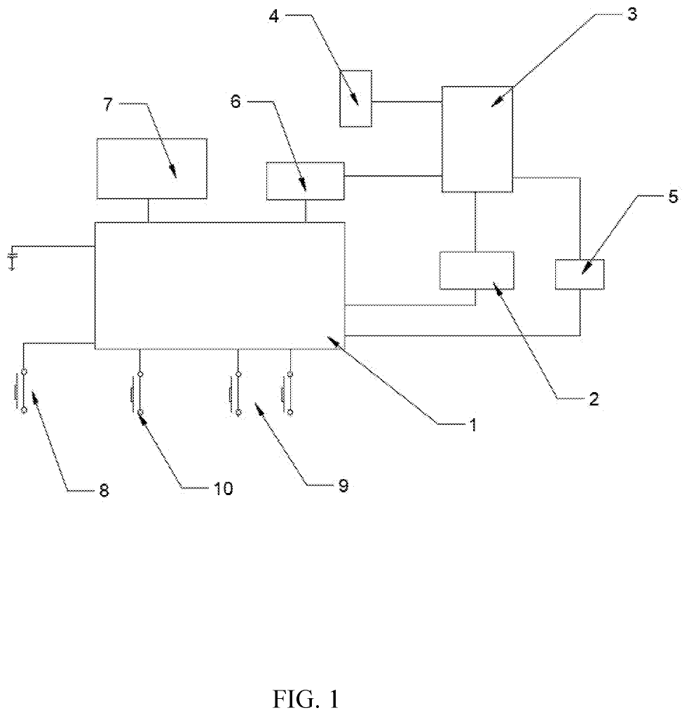

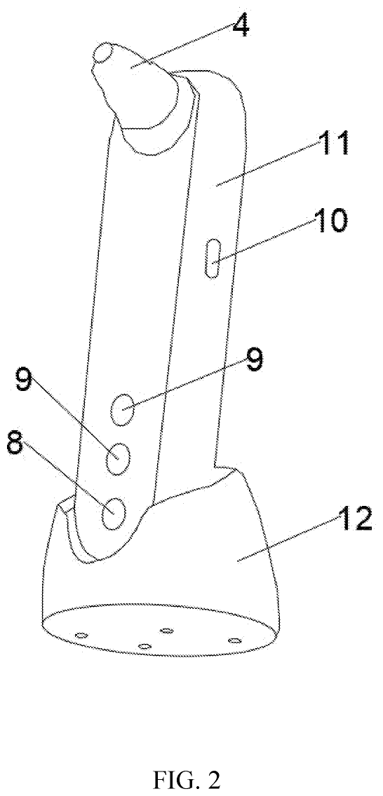

As shown in FIGS. 1-2, the present disclosure relates to a skin beauty suction device, the skin beauty suction device includes: a main control board 1, connected to a suction pump 2, where the suction pump 2 is connected to a suction nozzle 4 through a gas tube, a pressure sensor 6 is arranged between the suction pump 2 and the suction nozzle 4, and the pressure sensor 6 is electrically connected to the main control board 1; the main control board 1 is electrically connected to a display 7; the skin beauty suction device further includes: a handheld part 11 and a base 12, where the handheld part 11 and base 12 are connected, the main control board 1 and suction pump 2 are arranged in the handheld part 11, and the suction nozzle 4 is arranged at an end of the handheld part 11.

As shown in FIGS. 1-2, the skin beauty suction device further includes a vacuum chamber 3, where the suction pump 2 is in communication with the vacuum chamber 3 through a gas tube, the vacuum chamber 3 is in communication with the suction nozzle 4 and a deflation device 5 through a gas tube, the pressure sensor 6 is arranged on the vacuum chamber 3, and the pressure sensor 6 is electrically connected to the main control board 1. The deflation device 5 can help achieve moving, anti-injury protection, and stopping operating while the skin beauty suction device is in use. The deflation device may be a spring pressure relief button, or other pressure relief manual switch.

As shown in FIGS. 1-2, the pressure sensor 6 is a piezoresistive pressure sensor 6. The deflation device 5 may be a solenoid valve or pressure spring switch, or other deflation components, without specific limitation.

As shown in FIGS. 1-2, the pressure sensor 6 is arranged on the vacuum chamber 3.

As shown in FIGS. 1-2, the main control board 1 is connected to at least one of a battery or a power line interface. The embodiments will take a direct connection to the power line interface as an example. Of course, the battery is arranged in the handheld part or the battery is connected to an external charging power.

As shown in FIGS. 1-2, the main control board 1 is electrically connected to a power switch 8 through a wire.

As shown in FIGS. 1-2, the main control board 1 is connected to a suction adjustment device 9, and the suction adjustment device 9 is configured to adjust a pressure in the vacuum chamber 3.

As shown in FIGS. 1-2, the skin beauty suction device further includes a pressure relief valve 10, the main control board 1 is connected to the pressure relief valve 10, and the pressure relief valve 10 is configured to release the pressure in the vacuum chamber 3.

As shown in FIGS. 1-2, the power switch 8, suction adjustment device 9, and pressure relief valve 10 are arranged on the handheld part 11, and the vacuum chamber 3 is arranged on the handheld part 11.

The display 7 may be configured to display the pressure in the vacuum chamber 3, such that the pressure value can be known in time to better control the suction force and reduce the damage to the skin.

A wireless transmission module (not shown) may be further arranged in the handheld part, which is connected to the main control board, and the wireless transmission module transmits data from the pressure sensor to the mobile terminal.

As an alternative implementation, a displacement sensor (not shown) may be further arranged on the suction nozzle, which is connected to the main control board. The displacement sensor can show a path of displacement for better monitoring. A bottom of the base 12 may be arranged with a heating massage head, which can heat the skin. The heating massage head is connected to the battery and the main control board 1.

In the process of use, the suction nozzle 4 gets a stable vacuum and suction, the vacuum chamber 3 is connected to the suction nozzle 4 through the gas tube, the nozzle 4 is in contact with the human skin, and the blackheads in the human skin are sucked out through the negative pressure; after the device is turned on, the vacuum degree of the vacuum chamber gradually increases and is connected to the pressure sensor 6 through the gas tube, and the sensor detects the negative pressure value of the vacuum chamber and displays it on the display; when the negative pressure value reaches a set value, the suction pump 2 automatically stops pumping; at this time, when the vacuum degree of the vacuum chamber 3 decreases to a predetermined value, the main control board 1 controls the pumping pump 2 to operate and issues a signal to the pumping pump 2, and the pumping pump 2 will automatically turn on, and so on. In this way, the pressure can be well ensured and the damage to human skin may be reduced through the main control board 1 for timely control. The main control board 1 is a main board with control circuit. The suction nozzle 4 is configured to suck blackheads on a to-be-treated part of the human body.

The pressure sensor 6 transmits the pressure signal in the vacuum chamber 3 to the main control board 1, and the main control board 1 performs controlling.

In the present disclosure, a vacuum chamber 3 is arranged to operate on the patient's body part. The suction pump 2 in the embodiments is preferably a small pump and may be adjusted by gear. The display 7 may show the pressure inside the vacuum chamber 3. Control may be realized through the main control board 1 and/or through manual operation, which is convenient and achieves overall control in the process of sucking blackheads, thereby greatly reducing the occurrence of redness and avoiding skin damage, thus solving the technical problem of redness and skin damage due to the inability to detect and control the amount of pressure, which causes the sucking device to suck the skin with too much force.

The basic principle of the embodiments: when the power switch 8 is pressed, the suction pump is energized for suction to generate negative pressure; at this time, by adjusting the suction device (i.e., suction adjustment button), the vacuum degree (negative pressure strength) in the vacuum chamber 3 may be set; the display will show the set vacuum value. The vacuum chamber 3 increases the pumping volume to facilitate accurate adjustment of the vacuum degree and to get the vacuum degree and suction force with the suction nozzle 4 during use. The suction nozzle 4 is in contact with the human skin and the blackheads in the human skin are sucked out through the negative pressure. The pressure sensor 6 transmits the data signal to the main control board 1 and the data is displayed on the display 7. When the negative pressure value reaches the set value, the suction pump automatically stops pumping; and when the vacuum degree in the vacuum chamber 3 is reduced to the predetermined value as set, the suction pump will automatically turn on, and so on. The vacuum chamber 3 is connected to the deflation device 5 through the gas tube, and the user operates this product through the pressure relief valve 10 to quickly adjust the suction power of the suction nozzle 4 to avoid painful discomfort and damage to the skin caused by the excessive suction power of the product, thereby reducing or avoiding the problems of facial redness and swelling and sucking on the skin.

The above described is only preferred embodiments of the present disclosure only, and is not intended to limit the present disclosure, for the skilled person in the art, the present disclosure can have various changes and variations. Any modification, equivalent replacement, improvement, etc. made within the spirit and principles of the present disclosure shall be included in the scope of the present disclosure.

What is claimed is:

1. A skin beauty suction device, comprising: a main control board (1), connected to a suction pump (2); wherein the suction pump (2) is connected to a suction nozzle (4) through a gas tube, the suction nozzle (4) being configured to be in contact with a human skin to suck blackheads; a pressure sensor (6) is arranged between the suction pump (2) and the suction nozzle (4), and the pressure sensor (6) is electrically connected to the main control board (1); the main control board (1) is electrically connected to a display (7).

2. The skin beauty suction device according to claim 1, further comprising: a handheld part (11) and a base (12); wherein the handheld part (11) and the base (12) are connected, and the handheld part (11) has a hollow cavity; the main control board (1) and suction pump (2) are fixed in the handheld part (11), and the suction nozzle (4) is arranged at an end of the handheld part.

3. The skin beauty suction device according to claim 1, further comprising a vacuum chamber (3); wherein the suction pump (2) is in communication with the vacuum chamber (3) through a gas tube, the vacuum chamber (3) is in communication with the suction nozzle (4) and a deflation device (5) through a gas tube, the pressure sensor (6) is arranged on the vacuum chamber (3), and the pressure sensor (6) is electrically connected to the main control board (1).

4. The skin beauty suction device according to claim 1, wherein the pressure sensor (6) is a piezoresistive pressure sensor, and the pressure sensor (6) is arranged on a vacuum chamber (3).

5. The skin beauty suction device according to claim 2, wherein a wireless transmission module is further arranged in the handheld part (11), and the wireless transmission module is connected to the main control board (1) and configured to transmit data from the pressure sensor (6) to a mobile terminal.

6. The skin beauty suction device according to claim 1, wherein a displacement sensor is further arranged on the suction nozzle, which is connected to the main control board.

7. The skin beauty suction device according to claim 3, wherein the main control board (1) is connected to a battery and is electrically connected to a power switch (8) through a wire.

8. The skin beauty suction device according to claim 7, wherein the main control board (1) is connected to a suction adjustment device (9), and the suction adjustment device (9) is configured to adjust a pressure in the vacuum chamber.

9. The skin beauty suction device according to claim 8, further comprising a pressure relief valve (10); wherein the main control board (1) is connected to the pressure relief valve (10), and the pressure relief valve (10) is configured to release a pressure in the vacuum chamber.

10. The skin beauty suction device according to claim 9, wherein the power switch (8), the suction adjustment device (9), and pressure relief valve (10) are arranged on a sidewall of the handheld part (11), and the vacuum chamber (3) is arranged in the handheld part.
